(19) United States
(12) Patent Application Publication
(10) Pub. No.: US 2013/0297491 A1
(43) Pub. Date: Nov. 7, 2013

(54) PRODUCT-CENTRIC CHARGING SYSTEM AND METHOD

(71) Applicants: Joachim WAHLBERG, Brakne-Hoby (SE); Helen SJELVGREN, Karlskrona (SE); Kaj JONASSON, Ronneby (SE); Magnus WEDELIN, Karlshamn (SE); Marcus HOLGERSSON, Karlskrona (SE); Mikael DELVÉUS, Karslkrona (SE)

(72) Inventors: Joachim WAHLBERG, Brakne-Hoby (SE); Helen SJELVGREN, Karlskrona (SE); Kaj JONASSON, Ronneby (SE); Magnus WEDELIN, Karlshamn (SE); Marcus HOLGERSSON, Karlskrona (SE); Mikael DELVÉUS, Karslkrona (SE)

(73) Assignee: Telefonaktiebolaget L M Ericsson (publ), Stockholm (SE)

(21) Appl. No.: 13/464,397

(22) Filed: May 4, 2012

(51) Int. Cl. G06Q 20/22

(52) U.S. Cl. 705/39

(57) ABSTRACT

A method of operating a charging system (20) comprises acts of defining a pool of plural asset accounts (24) and classifying the asset accounts of the account pool according to one or more account type classifications; and storing at least one appropriate account type classification for a product. The method further comprises, upon receiving an indication of a service request (6-1) involving the product, obtaining at least one appropriate account type classification for the product; and selecting from the pool of plural asset accounts (24) one or more of the asset accounts belonging to the at least one appropriate account type classification to charge (e.g., reserve/deduct) for the service request involving the product.

### TECHNICAL FIELD

The technology relates to charging or financial account rendering for use of services, such as telecommunications services, for example.

### BACKGROUND

For many products and/or services a customer or subscriber desires that a financial charge for the product/service be satisfied or paid from one or more of accounts, e.g., asset accounts owned by the customer or authorized for the customer's use. The debiting of the appropriate accounts, or reserving of assets in the appropriate accounts, is generally handled by a charging system.

For some products, such as telecommunication products, a product offering configuration is typically prepared separately from and subsequently to design of the charging system which will be utilized to charge the customer for use of the product. By “product offering configuration” is meant the information which identifies or describes a product, e.g., a new product. In view of the pre-existent nature of the charging system, charging for the use of the product is dependent upon the account selection mechanism of the conventional charging system. This means that charging for new products must occur within the constraints of the account selection mechanism of the conventional charging system.

FIG. 1 illustrates example actions involved in a conventional “account-centered” charging system. Describing in general direction from the left to the right of FIG. 1, a service handling component of the conventional charging system receives an event from a network. For example, the service handling component may receive a service request and determine from the service request what type of service is involved. For a telecommunications system, the service request may be for, e.g., voice, data traffic, etc. The service handling component then attempts to identify the customer (not illustrated in FIG. 1), and thereafter invoke an account selection component of the charging system.

The account selection component attempts to determine, from account pre-analysis, what account(s) may be used based on a subscription for the identified customer. The input to query an account selection component is a combination of customer identifier, the segment (e.g., service class) of the customer, the service type, and maybe some other parameters that may be obtained from the network. Since one subscriber may have several different accounts, the account selection component attempts to determine which of the accounts are to be used (e.g., charged), or even if the account of another subscriber should be debited (e.g., a shared account).

It may be that plural accounts are found by the account selection component of the charging system. At this point the price for the service has not been calculated, the charging system now knowing basically only that a certain type of service used, who is calling and who is being called, to which segment or quality class the call belongs, and which accounts for are eligible for charging.

Then a service class rating component of the charging system is consulted via a rating request in order, e.g., to identify the priority order for the account. When the service class rating is obtained, the charging system may start calculating the price for that service (e.g., a cost calculation). For example, if the call is a voice call during busy hour, the call may cost X per minute, and for a reservation of y minutes, and then the charging system will calculate what the cost for the reservation, and then try to reserve money from one or more eligible accounts maintained by the account component of the charging system.

The charging system may employ one or more quote requests in order to try to reserve money from one or more accounts which have been identified as eligible accounts. The charging system receives a quote result from each account queried with a quote request. For example, the charging system may use a first quote request to first try to reserve money from a first eligible account. If the first eligible account has insufficient balance or is otherwise unavailable as indicated by the first quote result, the charging system will continue with a second quote request for a next eligible account, and then continue in a priority order of accounts until the charging system is able to reserve as much money as needed. It may be that one or more accounts have certain contexts or rules of availability, e.g., one account may only be allowed to be accessed for a specific service or a specific day or week; another account may be available only on weekdays from 8 am to 5 pm; yet another account may be available all day. The account selection component thus may put the accounts in prioritized order, and then the charging system performs a rating. Thus, the account selection component and the service class rating component must be synchronized. The service class rating component will try to reserve money from the account in the order specified in the account selection. It may not be possible to withdraw/reserve all the requested money from a first selected account, in which case the charging system continues in accordance with the prioritized listing of available accounts until the needed or requested amount is reserved. If the needed or requested amount cannot be fulfilled, then the call will not be granted, i.e., there will be a service denial.

Thus, in a conventional charging system such as that illustrated in FIG. 1, the account selection logic is called prior to calculating the cost. The selection logic is an account selection logic, which selects the different dedicated accounts to use.

In a conventional charging system such as that illustrated in FIG. 1, all accounts are aggregated together with a main account and seen as a pot of money during rating and charging. This means that follow up on different account types becomes difficult.

Thus, as mentioned above, one of the problems with the conventional charging system such as that described in FIG. 1 is that the product offering configuration and the account selection configuration is done separately. Hence, the conventional charging system does not guarantee a consistent configuration setup. This also makes it very hard to manage from, e.g., an external product catalog or product offering configuration.

Another problem is that the architecture of the conventional charging system requires the account selection of possible accounts to be done prior to the product selection. The constraining architecture of the conventional charging system presents at least the following difficulties:
The difficulty in creating a product offering without having the knowledge of the complete account structure within the charging system. When creating a product offering it would be preferable to know exactly which possible accounts can be chosen for charging based on the account selection configuration.
The difficulty in adding, changing, or removing accounts without changing the consuming products. This difficulty arises, at least in part, because the possible accounts to charge for the product has been configured outside of the product offering. If, for example, it is desired to remove an account in the account selection configuration, all product offerings using that account may need to be updated so as to select another account instead.
The difficulty in sharing accounts between products. The accounts to share will be limited, since only the pre-selected accounts can be used.
The difficulty in selecting from which account to reserve/deduct as a result of the cost calculation within a product, except from the pre-selected accounts done prior to the product selection.

Moreover, in the conventional charging system it is also not possible to address all accounts of a specific type without indicating each individual account.

Yet another problem with the architecture of the conventional charging system is that all dedicated accounts are aggregated together with a main account and seen as a pot of money during rating & charging. This hinders and complicates follow up on different account types.

### SUMMARY

In one of its aspects the technology disclosed herein concerns a method of operating a charging system. The method comprises acts of defining a pool of plural asset accounts and classifying the asset accounts of the account pool according to one or more account type classifications; and storing at least one appropriate account type classification for a product. The method further comprises, upon receiving an indication of a service request involving the product, obtaining at least one appropriate account type classification for the product; and selecting from the pool of plural asset accounts one or more of the asset accounts belonging to the at least one appropriate account type classification to charge (e.g., reserve/deduct) for the service request involving the product.

In an example embodiment and mode the method further comprises storing product charging/offering information for the product; and using the product charging/offering information to determine an amount to charge for the service request.

In an example embodiment and mode the method further comprises selecting, from the pool of plural asset accounts, a selected asset account to charge for the service request involving the product, the selected asset account belonging to the at least one appropriate account type classification and being sponsored by another product. In an example implementation the method further comprises using a product specification of the another product stored in the charging system to identify sponsorship of the selected asset account.

In an example embodiment and mode the method further comprises determining whether to create in the pool of plural asset accounts a product asset account for the product, the product asset account being classified according to the at least one appropriate account type classification for the product. In an example embodiment and mode the method further comprises upon creating the product asset account for the product, identifying the product asset account as a sponsored product asset account, only the product which sponsors the sponsored product asset account being eligible to fund the sponsored product asset account.

In an example embodiment and mode the method further comprises for the product, storing in the charging system a product specification which defines the at least one appropriate account type classification for the product; and using the product specification for determining whether to create the product asset account for the product.

In an example embodiment and mode the method further comprises classifying the asset accounts of the pool of plural asset accounts according to one or more pre-defined account type classifications, the at least one appropriate account type classification being one of the pre-defined account type classifications.

In an example embodiment and mode the method further comprises for the product, storing in the charging system a product specification which defines the at least one appropriate account type classification for the product; and, upon receiving the indication of the service request involving the product, obtaining from the product specification the at least one appropriate account type classification for the product and using the at least one appropriate account type classification to select the one or more of the asset accounts belonging to the at least one appropriate account type classification to charge for the service request involving the product.

In an example embodiment and mode the method further comprises associating, with each account type classification, plural account type parameters, the account type parameters comprising at least one of an account type unit of measure and an account type selection rule. In an example embodiment and mode the method further comprises using the account type selection rule to sequence charging for the service request from one or more asset accounts that belong to the at least one appropriate account type classification.

In an example embodiment and mode the method further comprises associating, with each account type classification, plural account type parameters, the account type parameters comprising an account type unit of measure.

In an example embodiment and mode the method further comprises maintaining a pool of plural products and, for each product in the pool, storing an indication of at least one of the appropriate account type classifications; and dynamically changing the constituent members of at least one of the pool of plural products and the pool of plural asset accounts during run time of the charging system.

In another of its aspects the technology disclosed herein concerns a method of operating a dynamically changeable charging system. The method comprises using a logic processing circuit to define a pool of plural asset accounts and classifying the asset accounts of the account pool according to one or more account type classifications; maintain a pool of plural products and, for each product in the pool, store an indication of at least one appropriate account type classification; handle service requests for the products in the pool of plural products by using the indication of the least one appropriate account type classification associated with the respective telecommunication products to select from the pool of plural asset accounts one or more of the asset accounts to charge [reserve/deduct] for the respective service requests; and dynamically change contents of one or both of the pool of plural asset accounts and the pool of plural products during run time of the logic processing circuit.

In another of its aspects the technology disclosed herein concerns a charging system. The charging system comprises a logic processing circuit; an asset account database; and, a product specification database. The logic processing circuit is configured to: define in the asset account database a pool of plural asset accounts and to classify the asset accounts of the account pool according to one or more account type classifications; store in the product specification database at least one appropriate account type classification for a product; upon receiving an indication of a service request involving the product, to obtain from the product specification database the at least one appropriate account type classification for the product; and select from the pool of plural asset accounts one or more of the asset accounts belonging to the at least one appropriate account type classification to charge [reserve/deduct] for the service request involving the product.

In an example embodiment the logic processing circuit is further configured to store, for the product, product charging/offering information (44); and use the product offering information (44) to determine an amount to charge for the service request.

In an example embodiment the logic processing circuit is further configured to select, from the pool of plural asset accounts, a selected asset account to charge for the service request involving the product, the selected asset account belonging to the at least one appropriate account type classification and being sponsored by another product.

In an example embodiment the logic processing circuit is further configured to use a product specification of the another product stored in the charging system to identify sponsorship of the selected asset account.

In an example embodiment the logic processing circuit is further configured to determine whether to create in the pool of plural asset accounts a product asset account for the product, the product asset account being classified according to the at least one account type classification for the product.

In an example embodiment the logic processing circuit is further configured, upon creating the product asset account for the product, to identify the product asset account as a sponsored product asset account, only the product which sponsors the product asset account being eligible to fund the sponsored product asset account.

In an example embodiment the logic processing circuit is further configured to, for the product, store in the charging system a product specification which defines the at least one appropriate account type classification for the product; use the product specification for determining whether to create the product asset account for the product.

In an example embodiment the logic processing circuit is further configured to classify the asset accounts of the pool of plural asset accounts according to one or more pre-defined account type classifications, the at least one appropriate account type classification being one of the pre-defined account type classifications.

In an example embodiment the logic processing circuit is further configured to, for the product, store in the charging system a product specification which defines the at least one appropriate account type classification for the product; and upon receiving from the telecommunications network the indication of the service request involving the product, obtain from the product specification the at least one appropriate account type classification for the product and using the at least one appropriate account type classification to select the one or more of the asset accounts belonging to the at least one appropriate account type classification to charge for the service request involving the product.

In an example embodiment the logic processing circuit is further configured to associate, with each account type classification, plural account type parameters, the account type parameters comprising at least one of an account type unit of measure and an account type selection rule.

In an example embodiment the logic processing circuit is further configured to use the account type selection rule to sequence charging for the service request from one or more asset accounts that belong to the appropriate account type classification.

In an example embodiment the logic processing circuit is further configured to associate, with each account type classification, plural account type parameters, the account type parameters comprising an account type unit of measure.

In an example embodiment the logic processing circuit is further configured to maintain a pool of plural products and, for each product in the pool, to store an indication of one of the account type classifications; dynamically change the constituent members of at least one of the pool of plural products and the pool of plural asset accounts during run time of the charging system.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view illustrating example acts of a conventional account-centric charging system.

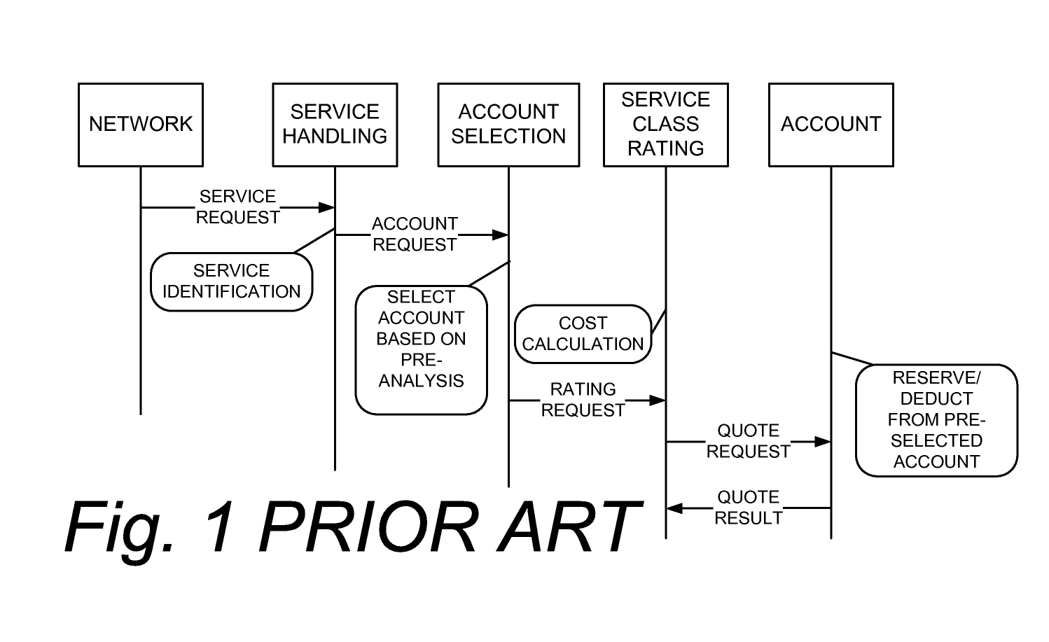

FIG. 2 is a schematic view of a generic product-centric charging system according to an example embodiment, shown as being accessed by a product consumer through a product utilization device.

FIG. 3 is a flowchart depicting example acts or steps included in a basic, representative method of operating a product-centric charging system.

FIG. 4 is a schematic view of a product-centric charging system according to an example, more detailed embodiment well as an example context in which the charging system operates.

FIG. 5A is a diagrammatic view illustrating a property of an account-using product; FIG. 5B is a diagrammatic view illustrating a property of an account-owning product; and, FIG. 5C is a diagrammatic view illustrating how account behavior and AccountType specified in the Product Offering may be used by its Product to address the appropriate account.

FIG. 6 is a diagrammatic view illustrating example acts of a product-centric charging system according to an example embodiment.

FIG. 7 diagrammatic view illustrating a pool of example products as well as corresponding product specifications and contents of an asset accounts database therefor.

FIG. 8 is a flowchart depicting example acts or steps included in a basic, representative method of dynamically operating a product-centric charging system.

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

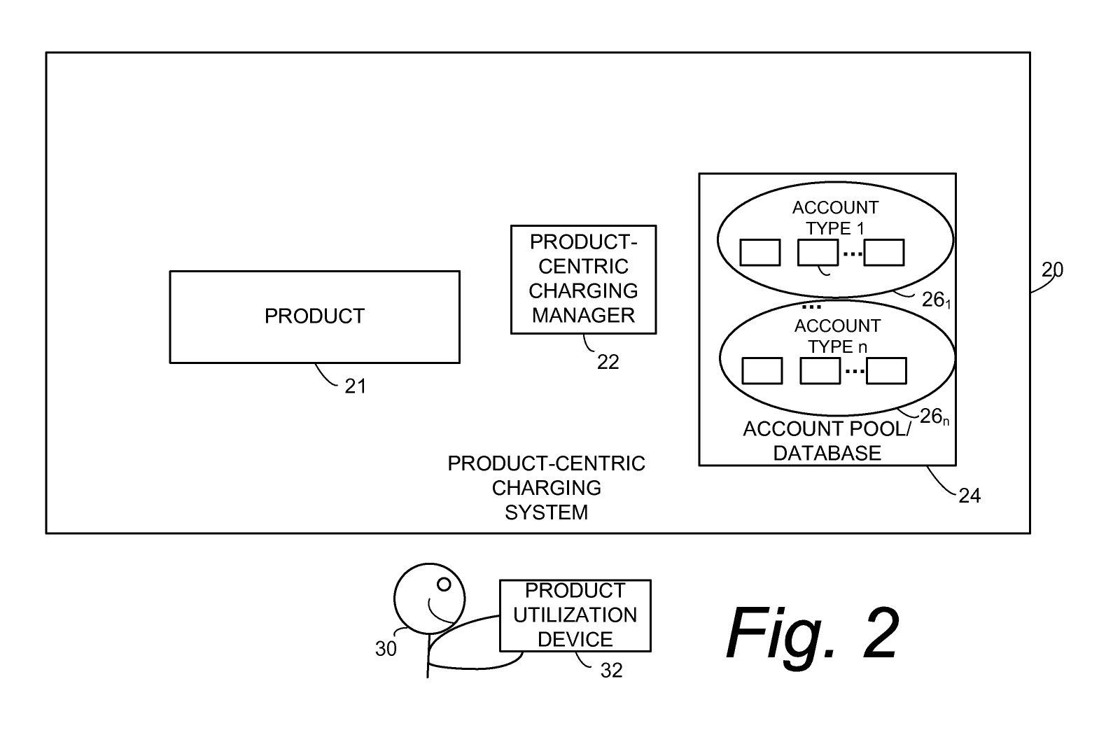

FIG. 2 illustrates an example, generic embodiment of a charging system 20 which operates in product-centric manner to select, upon usage of a product (such as product 21), one or more appropriate asset accounts to charge for the usage. The charge for the usage may take the form of an actual debit from the appropriate asset account(s) or a reservation of resources from the appropriate asset account(s). FIG. 2 particularly shows that charging system 20 comprises product-centric charging manager 22 which has access to and/or operates on a pool 24 of plural asset accounts. The asset accounts of the pool of asset accounts 24 are shown as grouped into account type classifications, e.g., the assets of account type classification “1” being shown in group 26₁ and the assets of account type classification “n” being shown in group 26ₙ. The product 21 is also classified according to at least one of the account type classifications. As described herein, when a charge needs to be made for use of a product, the product-centric charging manager 22 selects from the pool of plural asset accounts 24 one or more of the asset accounts belonging to the appropriate account type classification(s) (the account type classification(s) of the product 21) to charge for a service request involving the product 21. In this way the charge may to be an appropriate one of any of the similarly account-type classified asset accounts of the pool 24, based on the account type classification of the product 21, thus rendering the charging “product-centric” rather than account-centric.

In contrast to an account centric charging system, in a product-centric system accounts may be shared between products. Moreover, products may be shared between subscribers, but each product is still kept self contained and independent of other products. A product-centric system with account type addressing may also add, change, and remove accounts without changing the consuming products.

As used herein, a “product” is not limited to a device or apparatus, but may comprise any service or commodity, whether offered for use or sold. Nor is the term “product” as used herein limited to any particular industry, commerce, or service. For example, the product may be a telecommunications product, a telemarketing product, an internet or web-based product, a financial or banking product, to name a few.

As used herein, a “telecommunications product” is not limited to a telecommunications device, but may comprise any commodity provided (e.g., offered or sold) by a telecommunications provider or network operator. For example, a telecommunications product may comprise a service plan or subscription such as a telecommunications voice service plan, or a telecommunications data service plan, or a plan which includes a combination of voice and data and/or other services. Moreover, a telecommunications product may also include one or more commodities that are described in other offerings of a telecommunications provider or network operator, such as purchasable deals for one or more services or features. Such deals may be characterized by time duration, time of the week or day, geographic location, nature of content (e.g., video), etc.

Typically the product consumer (e.g., a purchaser or recipient of the product 21) accesses the product 21 through a product utilization device. Accordingly, FIG. 2 shows product consumer 30 as using product utilization device 32 to gain access to product 21. The product consumer 30 may be human as in the case shown in FIG. 2, but also could be non-human equipment in the form, for example, of a computer or computer system or other automated consumer. In some cases the product utilization device 32 may be a telecommunications device such as a stationary (landline) or wireless terminal (e.g., cell phone, smart phone, UE, or mobile terminal, laptop with mobile termination).

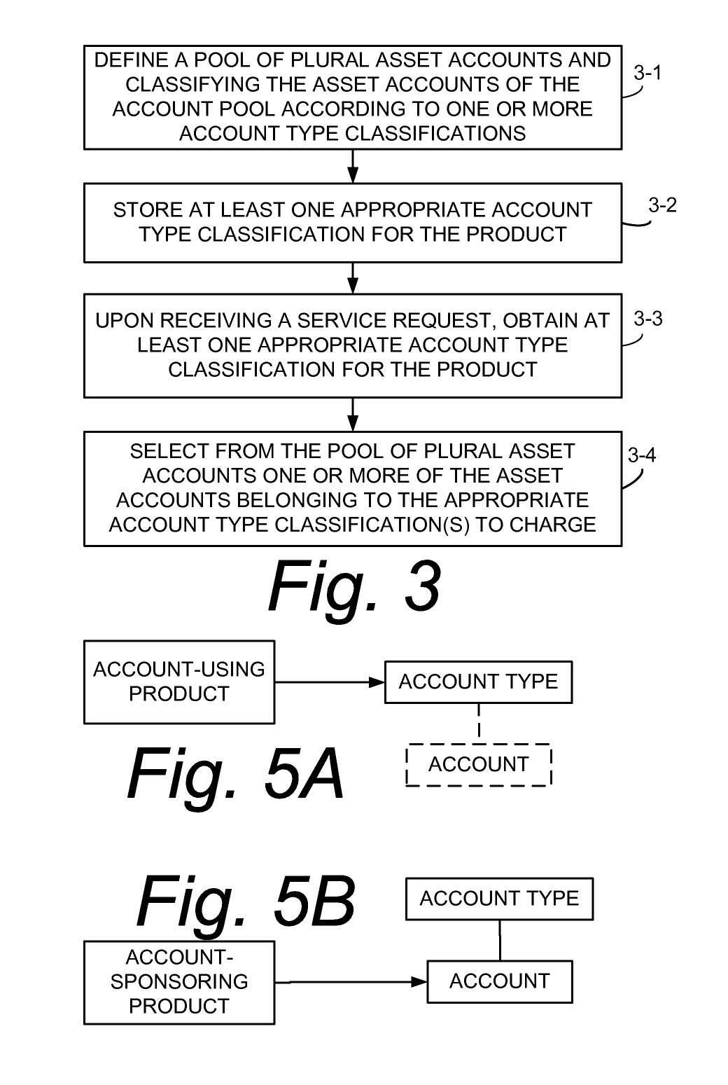

FIG. 3 shows example acts or steps included in a basic, representative method of operating the generic charging system 20 of FIG. 2. Act 3-1 comprises defining the pool 24 of plural asset accounts, and classifying the asset accounts of the account pool 24 according to one or more account type classifications (e.g., as belonging to the account type classification of group 26₁, or to the account type classification of group 26₂, or so forth). Act 3-2 comprises storing at least one account type classification for the product. Act 3-3 comprises, upon receiving an indication of a service request involving the product, obtaining at least one appropriate account type classification for the product. Act 3-4 comprises selecting, from the pool of plural asset accounts, one or more of the asset accounts belonging to the appropriate account type classification(s) to charge (e.g., from which to reserve or deduct) for the service request involving the product. Thereafter, the selected asset account(s) are charged by the charging system for use of the product in accordance with the service request.

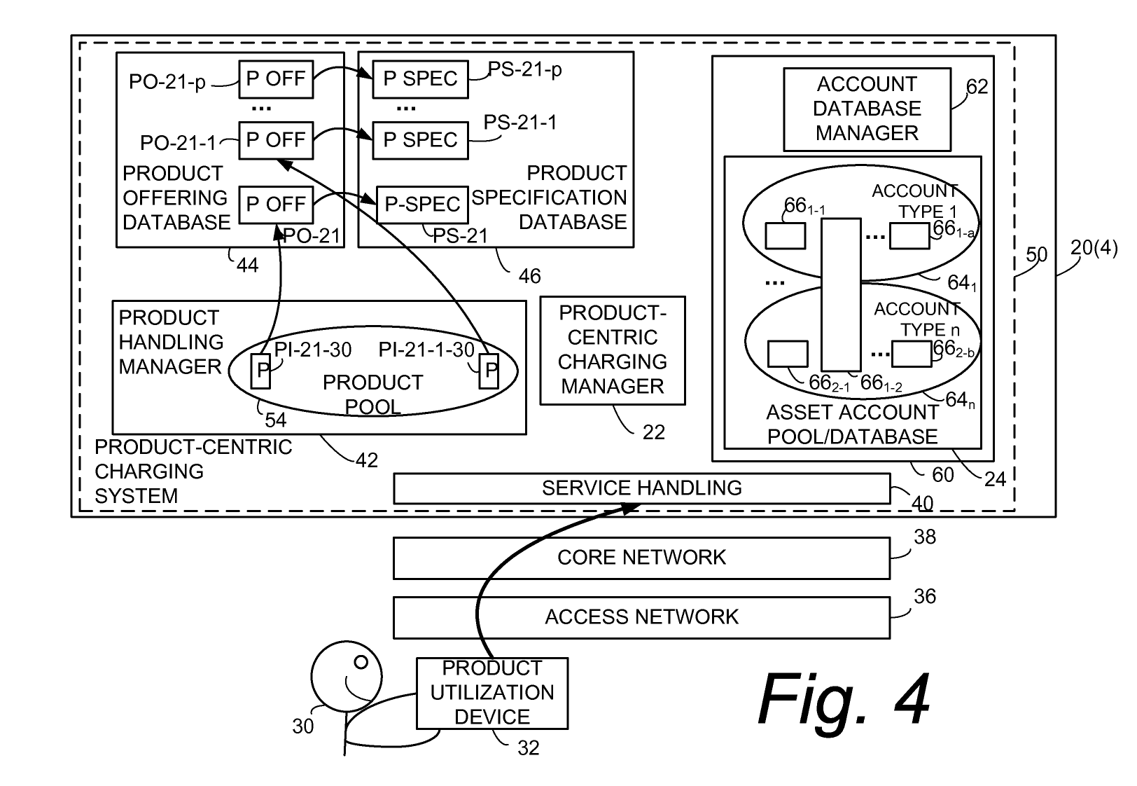

FIG. 4 shows an example embodiment of charging system 20(4) in more detail, as well as an example context in which the charging system 20(4) operates when the product utilization device 32 is a wireless terminal. In particular, FIG. 4 shows that product utilization device 32 is connected by access network 36 to core network 38, and that from core network 38 the charging system 20(4) receives service requests. The access network 36 can be any suitable type of access network, a radio access network being just one example.

FIG. 4 further shows that the example charging system 20(4) comprises various constituent charging functionalities or units in addition to product-centric charging manager 22 and the pool 24 of plural asset accounts. Among the example functionalities shown are service handling unit 40; product handling manager 42; product offering database 44; product specification database 46. In FIG. 4, the pool 24 of plural asset accounts is also shown/known as asset account database 24.

In an example embodiment and as depicted by way of example in FIG. 4, the charging system 20 and particularly product-centric charging manager 22 may be realized by a machine platform. To this end FIG. 4 employs a broken line to represent machine platform 50 which comprises charging system 20(4). The terminology “machine platform” is a way of describing how the functional units of charging system 20(4) can be implemented or realized by machine. The machine platform 50 can take any of several forms, such as (for example) logic processing circuitry such as, but not limited to, electronic circuitry in the form of a computer implementation platform or a hardware circuit platform.

As shown in FIG. 4, product offering database 44 includes a “product offering” for plural products. As mentioned above, a “product” is not limited to a device or apparatus, but may comprise any service or commodity, whether offered for use or sold and is not limited to any particular industry, commerce, or service. In some example implementations described herein one or more of the products may be a telecommunications product.

The product offering database 44 of FIG. 4 shows availability not only of the aforementioned product 21, but also products 21-1 through 21-p. In other words, FIG. 4 shows product offerings in terms of entries or product offering records (P OFF) PO-21 through PO-21-p for each of products 21 through 21-p, respectively. Product offering database 44 contains information that is presented to the customer for identifying and/or advertising the product, e.g., sales or use contract terms.

For each product offering in product offering database 44 there is a corresponding product specification (P SPEC) in product specification database 46, e.g., product specifications SP-21 through SP-21-p for each of products 21 through 21-p, respectively. As shown by an arrow in FIG. 4, each record or entry in product offering database 44 points or refers or incorporates a corresponding entry or record (e.g., specification) in product specification database 46. A product specification in the product database 46 includes a description of the product, including what services the product may use, how to charge for the product, how the product is rated (e.g., quality of service rating), and the technical specifications for the product, etc. The price may be fixed (e.g., flat), or may vary according to policies articulated in the product specification database 46. For example, the product specification for one product might be for a voice service with two different prices, one price for daytime and another price for nighttime.

In an example embodiment, the product specification included in product specification database 46 may specify necessary technical details needed for a product. Among other things, the product specification includes an account specification and a charging specification. The account specification specifies a specific account of a specific account type and/or a reference to an existing account type. The charging specification uses the information from the account specification and indicates if charges will be withdrawn from the specified account or from the specified account type.

When a customer purchases or otherwise acquires a product defined by a product offering, an “instance” of the purchased product is created in product pool 54 for the customer. For example, if customer 30 purchases the product 21 defined by the product offering PO-21 in product offering database 44, a product instance PI-21-30 is created in product pool 54. As shown by an arrow, the product instance PI-21-30 refers or points to or incorporates the product offering PO-21 in product offering database 44. As mentioned above, a product offering PO-21 in product offering database 44 in turns refers or points to or incorporates the product specification PS-21 in product specification database 46 (as shown by another arrow). The same customer 30 may also have purchased product 21-1, and thus would have product instance PI-21-1-30 in product pool 54. Although not shown in FIG. 4, the product pool 54 also includes product instances for other customers for one or more products. For example, if another customer purchases a product according to the product offering for product 21, the product pool 54 will include an instance of product 21 for that other customer.

Thus, when a product is purchased or acquired through acceptance or purchase of a product offering, the charging system 20 creates an instance of the product in product pool 54. The instance of the product refers to the corresponding record in product offering database 44, which in turn refers to the corresponding specification for that product in product specification database 46.

The product-centric charging system 20 utilizes an “account type” classification as a way to represent a number of accounts which can be charged upon product usage. An account is an instantiated asset that belongs to a certain account type. An account can be seen as an asset container holding e.g. monetary units, counter, pieces, etc.

In the above regard FIG. 4 also shows pool 24 of plural asset accounts in more detail for an example embodiment. The pool 24 of plural asset accounts comprises or at least partially forms account subsystem 60 of charging system 20. The account subsystem 60 includes not only the pool 24 of plural asset accounts, but also an account database manager 62. The account database manager 62 serves essentially as an interface for access (e.g., input and output operations) with respect to the accounts maintained in the pool 24 of plural asset accounts.

As explained with reference to act 3-1 of FIG. 3 and also illustrated in FIG. 4, each of the asset accounts in the pool 24 is classified according to one or more “account types”, e.g., “account type classifications”. FIG. 4 shows a range of account type classifications, e.g., account type 1 through and including account type n. The accounts of each account type classification are shown at being at least partially within a corresponding oval, either the oval of account type classification 64₁ for account type classification “1” or the oval of account type classification 64ₙ for account type classification “n”. In the particular implementation or scenario shown in FIG. 4, accounts 66₁₋₁, 66₁₋₂, and 66₁₋ₐ have been classified as account type classification 1 (and thus are at least partially in subpool or oval 64₁); accounts 66₂₋₁, 66₁₋₂, and 66₂₋₁, have been classified as account type classification 2 (and thus are at least partially in subpool or oval 64₂). In the situation of FIG. 4, account 66₁₋₂ has been classified as both account type classification 1 and account type classification 2, and thus resides at least partially in each of sub-pools or ovals 64₁ and 64₂.

Each “account type” or “account type classification” may have a name and one or more parameters for the account type. Table 1 provides selected examples of account types (e.g., account type classifications), with account type names being depicted in the second column of Table 1 and various parameters or descriptive fields shown in other columns of Table 1. In some of the example account types of Table 1, the account type defines, among other things, a unit of measure, currency and account selection rule.

TABLE 1
Example Account Type Classifications

| | | | | | Account |
|---|---|---|---|---|---|
| Account | | Descrip- | Unit of | | selection |
| Type key | Name | tion | measure | Currency | rule |
| VolumeCount | Volume | Count | Bytes | — | First |
| | Counter | downlink | | | expiry |
| | | volume | | | first |
| SMSMoney | SMS | Money for | Monetary | SEK | Least |
| | money | SMS | | | amount |
| | | | | | first |
| SMSCount | SMS | Counter | # of | — | Closest to |
| | count | for | messages | | threshold |
| | | SMS | | | first |

Table 2 shows an example of how an account of a certain AccountType may be defined in/during a product Offering definition.

TABLE 2
Example Account Type Definitions in Product Offering

| Account | Account | Account | AccountType | Account | Private | Initial |
|---|---|---|---|---|---|---|
| behavior | name | description | key | Threshold | (Y/N) | amount |
| Owning | MySMS | An account holding | SMS Money | 10 | N | 100 |
| | Money | the monetary | | | | |
| | | SMS balance. | | | | |
| Using | MySMS | An account holding | SMSCount | 5000 | NAP for | NAP for |
| | Counter | the aggregated | | | using | using |
| | | number of sent SMS | | | accounts | accounts |

As one aspect of the technology disclosed herein, a product may be categorized as either an “account-sponsoring”/“account-owning” product on the one hand, or an “account-using” product on the other hand. Such categorization of the product as either “account-sponsoring” or “account-using” may occur as an indication stored, e.g., in the respective product offering (e.g., in the respective record for the product in product offering database 44).

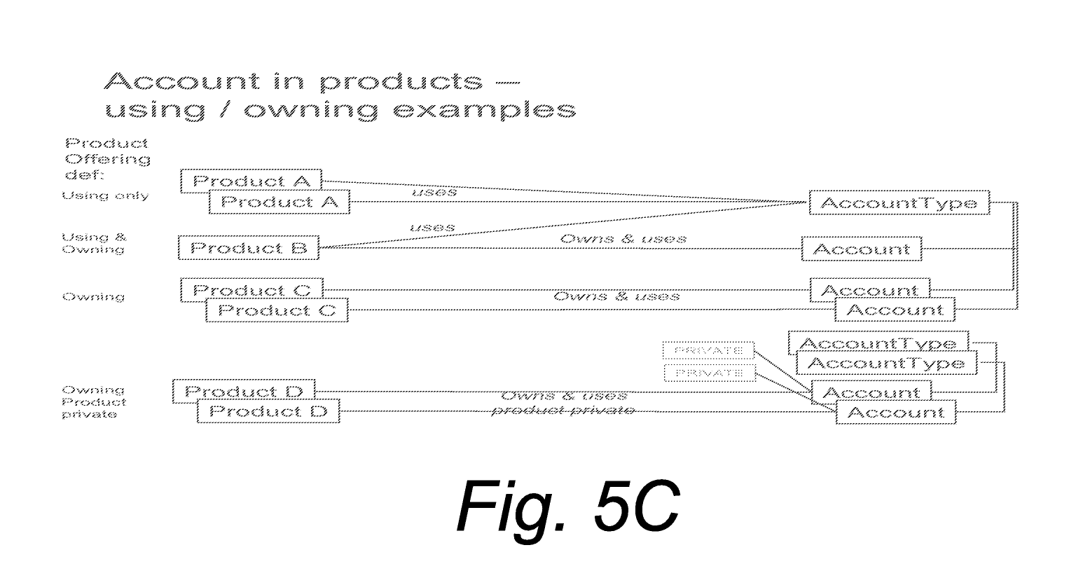

Selected characteristics of an “account-using” product are illustrated in FIG. 5A. For an “account-using” product no specific account is defined or instantiated in the pool 24 of plural asset accounts. The charge for an “account-using” product may be assessed against one or more accounts, owned by other products, with the specified Account Type, e.g., with the same account type classification as the “account-using” product. That is, if the product specification defines the product as an “account-using” product, the instantiated product may deduct from all other accounts owned or sponsored by other products which have the same AccountType as referenced to in the “account-using” product's product offering. If the product offering defines the product as an “account-using” product, the instantiated product cannot add any amount to any account in the pool 24 of plural asset accounts, but instead may only consume from the accounts without funding the used accounts.

Selected characteristics of an “account-sponsoring” product, also known as an “account-owning” product, are illustrated in FIG. 5B. When an instance of an “account-sponsoring” product is created in product pool 54, a specific new corresponding account is also instantiated in pool 24 of plural asset accounts. The type of the new account in pool 24 is the same as the Account Type of the product (as defined by the product specification). The instantiated product essentially “sponsors” or “owns” the newly instantiated account. Thus, a creation of an “account-sponsoring” product will result in a corresponding instantiated account in pool 24 of plural asset accounts at the time of product instantiation (e.g., upon contracting for the new product). A “account-sponsoring” product, since it sponsors or owns the corresponding account, can add an initial amount to the account at product instantiation, can add further amounts to increase the balance of the account at other times, and (of course) can deduct from the account as well. If the “account-sponsoring” product is further specified as being a “private account-sponsoring” product, the account in the pool 24 of plural asset accounts which is instantiated is a private account and no other product(s) can deduct from the private account.

As evident from the above, the term “balance” is sometimes used herein synonymously with the term “account” but may, depending on the context, refer also to the value of an account.

Thus, when a product has its own account assets such owned account is referred to that as a sponsored account, e.g., the account that the product “owns”. In some situations a subscription may involve plural different products, and not every product may have its own assets (e.g., not every product may be an account-owning or accounts-sponsoring product), and therefore is an “account-using” product. An account-owning product can also use assets that are owned by another product. The product specification specifies whether a product will be an “account-owning” product or an “account-using”. The “account specification” portion of the product specification indicates what type of account is required.

FIG. 5C illustrates how the account behavior and AccountType specified in the Product Offering may be used by its Product to address the appropriate account.

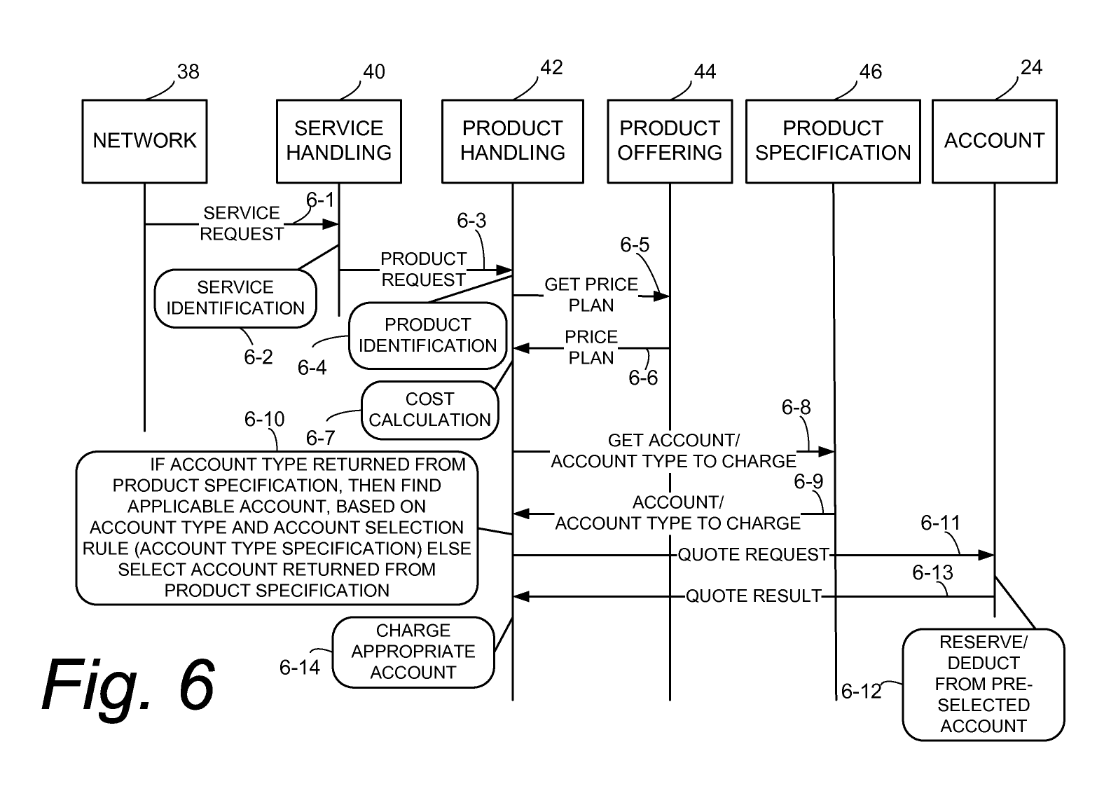

FIG. 6 illustrates example acts of a product-centric charging system according to an example embodiment. The acts of FIG. 6 are coordinated and controlled by the product-centric charging manager 22 of the charging system 20. Act 6-1 of FIG. 6 represents receipt of a service request. The service request of act 6-1 may be from a network, e.g., a telecommunications network. The service request of act 6-1 may be prompted by some event in the network that requires a payment or reservation of funds from an account in order for the service to be initiated or continued. The service request of act 6-1 is received by service handling unit 40. Act 6-2 of FIG. 6 comprises the service handling unit 40 identifying the service, e.g., a voice service or data service, for example.

Then, rather than proceeding to account selection as would a conventional charging system, the product-centric charging manager 22 has service handling unit 40 make a product request (act 6-3) of the product handling manager 42. The purpose of the product request of act 6-3 is to identify which products of product pool 54 may be appropriate for the service request issued as act 6-1. The service request of act 6-1 may have been issued for a voice service, so in response to the product request of act 6-3, as act 6-4 the product handling manager 42 checks the product pool 54 for the customer for whom the service request was issued and makes a product identification. The product identification of act 6-4 may indicate that the customer has two voice products, e.g., a first product being an ordinary voice product and a second voice product being a discounted voice product. So as a result of the product request of act 6-3, as act 6-4 the eligible products suitable for the particular service request are identified.

Having identified the eligible products available to the customer for the particular service for which the service request was received, the pricing plan for each of the eligible products must be fetched. Act 6-5 comprises the product handling manager 42 requesting, from product offering database 44, a price plan for each of the eligible products identified by act 6-4. As act 6-6 the product offering database 44 returns a price plan for each eligible product. Based on the price plans return as act 6-6, the product handling manager 42 determines which of the eligible products has the most favorable price plan, and for the most favorably priced product makes a cost calculation as act 6-7. In the example scenario being discussed, the discounted voice product would be the most favorable, and accordingly as act 6-7 the cost calculation for the service request of act 6-1 is made with respect to the discounted voice product.

Having determined what product is to be allocated to the service request, and the cost of the product in fulfillment of the service request, the product-centric charging manager 22 seeks to determine which asset account of pool 24 of plural asset accounts is to be charged, debited, or have assets reserved for the service request. Accordingly, as act 6-8 the product handling manager 42 sends a request to product specification database 46 in order to determine which account, or which account type, is to be charged for the service request. In this regard, the customer's instance of the selected product is linked through the product offering database 44 to the product specification database 46, as shown by arrows in FIG. 4. As act 6-9 the product specification database 46 returns either an identification of an account or an account type classification which is appropriate to charge for the product which is allocated to the service request of act 6-1. In the example scenario being discussed, an appropriate account type classification may be “voice money”.

Having received from 46 either the account or the appropriate account type classification for the product, as act 6-10 the product handling manager 42 attempts to determine the appropriate asset accounts in pool 24 of plural asset accounts that may be charged, debited, or reserved for the service request of act 6-1. If all that is returned from the product specification database 46 as act 6-9 is an identification of a particular account, or a particular code that indicates that only one particular account may be charged, then such particular account will be charged for the service request. But if the product specification database 46 returns a account type classification as act 6-9, the determination of act 6-10 is based on the account type classification for the product and possibly other information as well, such as an account selection rule which may comprise the account type definition. If an account type classification is returned from product specification database 46, act 6-10 comprises consulting the accounts for the corresponding account type 64 and, as illustrated by act 6-11, issues a quote request to one or more asset accounts of the account type classification 64 which is associated with the customer.

The number and order (e.g., sequence) of such quote requests may be determined by the account selection rule associated with the account type. As each asset account is checked, as act 6-12 the asset account tentatively or preliminarily reserves or deducts from its balance as much as the asset account can contribute toward payment of the cost calculated at act 6-7. The amount so reserved or deducted toward payment of the cost calculated at act 6-7 is returned in a quote result of act 6-13 to product handling manager 42. If the asset account which is consulted first in the sequence is able to cover the entire calculated cost, then no other asset account need be consulted. But if the amount reserved or deducted toward payment of the cost is insufficient to cover the entire cost calculated at act 6-7, the product handling manager 42 may send quote requests (act 6-11) to other asset accounts in, e.g., an order provided by any account selection rule defined for the account type.

After quote results (act 6-13) are obtained from one or more asset accounts, as act 6-14 the product handling manager 42 actually charges the appropriate asset accounts. In such case the tentative or preliminary reservations or deductions of act 6-12 may be finalized.

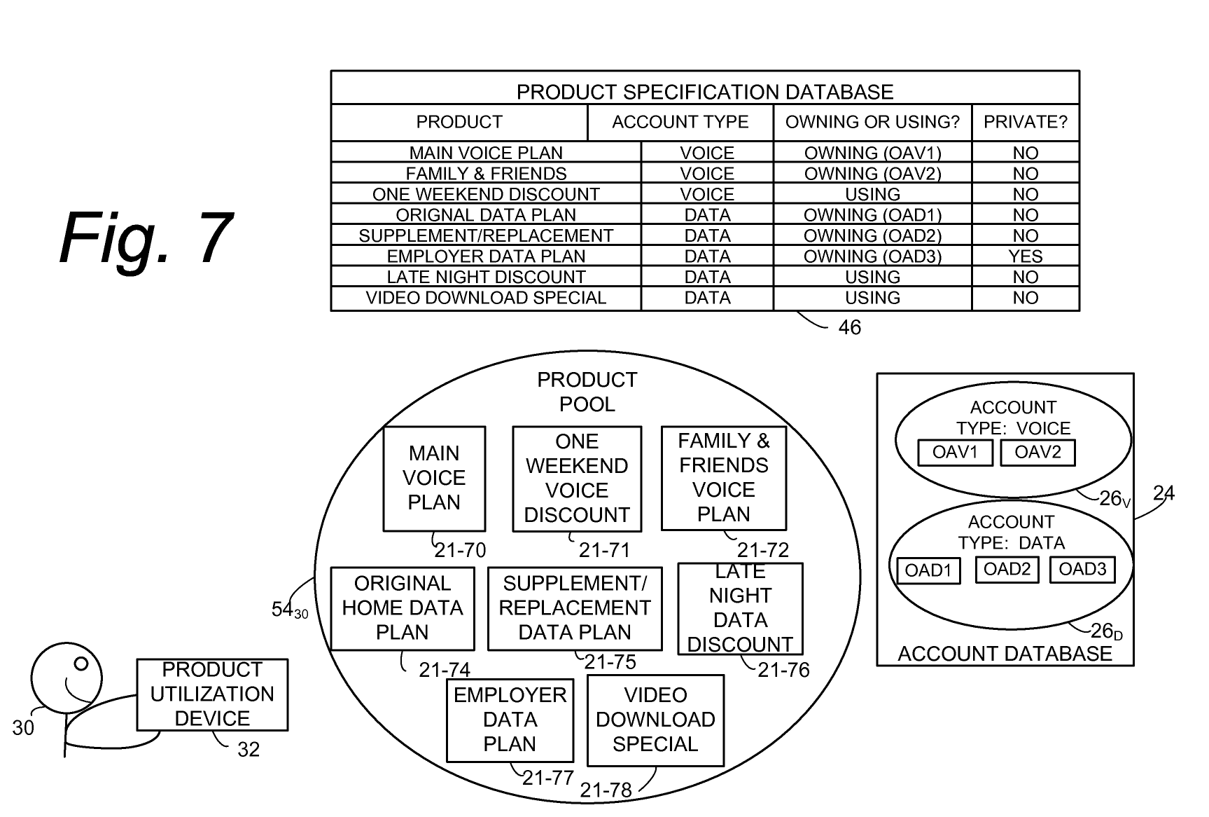

FIG. 7 illustrates a pool of example telecommunication products as well as corresponding product specifications and contents of an asset accounts database therefor. FIG. 7 particularly shows instances of products in product pool 54₃₀ for product consumer 30, and the corresponding entries in product specification database 46 for each such product. For sake of illustration, FIG. 7 shows the product pool 54 for product consumer 30 as comprising instances for three voice plan products and instances for five data plan products.

The three voice plan products having instances for product consumer 30 in product pool 54 are main voice plan 21-70; a one weekend voice discount plan 21-71; and, a family and friends voice plan 21-72. Each of these voice plans is shown in product specification database 46 to have an account type of “VOICE”. Of these three voice plans, the product specification database 46 indicates that the first two are “account-sponsoring” or “account-owning” products (e.g., OAV), with main voice plan 21-70 owning an account OAV1 in account type classification 64_{V} (which has account type classification “VOICE”) and one weekend voice discount plan 21-71 owning an account OAV2 in account type classification 64_{V}. The family and friends voice plan 21-72 is shown in product specification database 46 to be an “account-using” product.

In the context of the example of FIG. 7, if the service request of act 6-1 were for a voice service, then as act 6-4 the product handling manager 42 may identify each of main voice plan 21-70; one weekend voice discount plan 21-71; and the family and friends voice plan 21-72 as eligible products. As acts 6-5 and 6-6 the pool 24 of plural asset accounts would request and receive price plans for each such eligible product and then chose the most favorably priced one of the eligible products to use for the service request. If, for example, the service request occurred in connection with a call to a relative or family member enrolled in the family and friends voice plan, the family and friends voice plan 21-72 may have the most favorable available price plan. As act 6-10 the product handling manager 42 determines from which of the asset accounts to obtain quotes, and if the family and friends voice plan 21-72 has the most favorable available price plan, the account type classification of the asset accounts to check is VOICE, e.g., account type classification 64_{V}. Using applicable account selection rule for a VOICE account type, the product handling manager 42 may obtain quotes from accounts OAV1 and/or OAV2. Ultimately as act 6-13 appropriate one(s) of the accounts OAV1 and/or OAV2 is charged.

The five data plan products having instances for product consumer 30 in product pool 54 are original home data plan 21-74; supplement/replacement data plan 21-75; late night data discount plan 21-76; employer data plan 21-77; and, video download special plan 21-78. Each of these data plans is shown in product specification database 46 to have an account type of “DATA”. Of these, original home data plan 21-74 may be the plan historically used by and still available to product consumer 30, but scheduled for soon phase out in favor of the supplement/replacement data plan 21-75. As further products the product consumer 30 has purchased the late night data discount plan 21-76 (which provides more favorable data rates at non-peak, late night hours) and the video download special plan 21-78. In addition to these four personal or household plans, the product consumer 30 also has access to the employer data plan 21-77, ostensibly for professional purposes. Of these five data plans, the product specification database 46 indicates that the first two and fourth are “account-sponsoring” or “account-owning” products (e.g., OAD), with original home data plan 21-74 owning an account OAD1 in account type classification 64_{D} (which has account type classification “DATA”); supplement/replacement data plan 21-75 owning an account OAD2 in account type classification 64_{D}; and employer data plan 21-77 owning an account OAD3 in account type classification 64_{D}. The late night data discount plan 21-76 and the video download special plan 21-78 are shown in product specification database 46 to be “account-using” products.

As shown in FIG. 7, the product specification database 46 may include a field which specifies whether an account “owned” or “sponsored” by a particular product is public or private account. If the account is a private account, only the account-owning or account-sponsoring product may debit or reserve against the private account. For example, the account OAD3 owned by employer data plan 21-77 is a private account.

In the context of the example of FIG. 7, if the service request of act 6-1 were for a data service, then as act 6-4 the product handling manager 42 may identify each of original home data plan 21-74; supplement/replacement data plan 21-75; late night data discount plan 21-76; employer data plan 21-77; and, video download special plan 21-78 as eligible products. As acts 6-5 and 6-6 the pool 24 of plural asset accounts would request and receive price plans for each such eligible product and then chose the most favorably priced one of the eligible products to use for the service request. If, for example, the service request occurred in connection with a call to a late night internet download, the late night data discount plan 21-76 may have the most favorable available price plan. As act 6-10 the product handling manager 42 determines from which of the asset accounts to obtain quotes, and if the late night data discount plan 21-76 indeed has the most favorable available price plan, the account type classification of the asset accounts to check is DATA, e.g., account type classification 64_{D}. Using applicable account selection rule for a DATA account type, the product handling manager 42 may obtain quotes from accounts OAD 1 and/or OAV2 and/or OAD3. Ultimately as act 6-13 appropriate one(s) of the accounts OAD 1 and/or OAV2 and/or OAD3 is charged.

It should be understood that the instances of products in product pool 54 available to product consumer 30 at any given time may change in accordance with product purchase and expiration timing. Moreover, the asset accounts which may be chargeable or otherwise usable by the product consumer 30 may also change over time, particularly as “account-sponsoring” or “account-owning” products are added or removed from the pool 24 of plural asset accounts.

The technology disclosed herein facilitates access to many different products that are potentially using many different types of accounts. In an example embodiment of the technology disclosed herein a determination is made in runtime as to which account is to be used. The determination of asset account to use is not made by hard pre-defined rule or hard relation. The technology disclosed herein uses an “account type classification” to handle subscriptions with new products so that the products and subscriptions can find each other during execution. In the past, the conventional charging system had to select the account purposely, identifying the types of services and then selecting the account. But the product-centric charging manager 22 of the technology disclosed herein instead looks at the products available, and then based on the products determines what accounts may be charged.

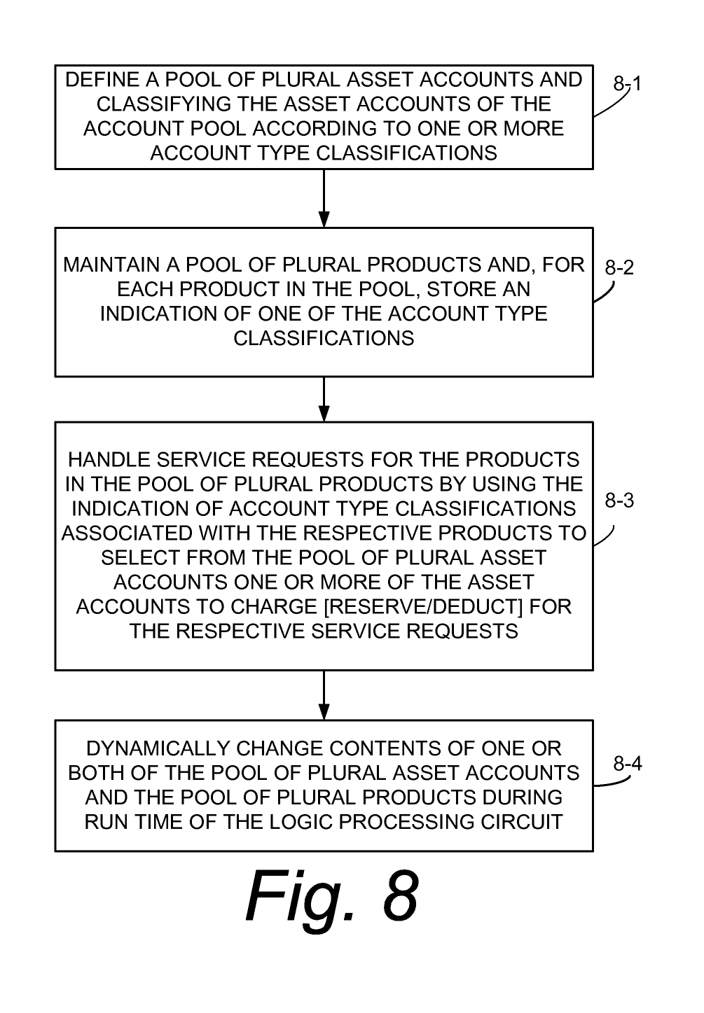

FIG. 8 shows representative, basic acts or steps which may be executed and which emphasize the dynamic operation of an example embodiment of a product-centric charging system of the technology disclosed herein. The acts of FIG. 8 may be performed during run-time or execution time of a processor, such as processor or platform 50. Act 8-1 comprises defining a pool of plural asset accounts (e.g., pool 24 of plural asset accounts) and classifying the asset accounts of the account pool according to one or more account type classifications. Act 8-2 comprises maintaining a pool of plural products and, for each product in the pool, storing an indication of at least one appropriate account type classification. As used herein, the pool of plural products may comprise or encompass the product pool 54 of product instances created upon purchase or acquisition of a product defined by a product offering in product offering database 44. The account type classification for the product may be stored in the product specification database 46. Act 8-3 comprises handling service requests (such as service request 6-1) for the products in the pool of plural products by using the indication of the least one appropriate account type classification associated with the respective telecommunication products to select from the pool of plural asset accounts one or more of the asset accounts to charge for the respective service requests. As used herein, “charge” may encompass, e.g., a reservation of funds or a deduction from an account. Act 8-4 comprises dynamically changing contents of one or both of the pool of plural asset accounts and the pool of plural products during run time of the processor 50.

In the account centric world or the subscription centric world essentially everything was modeled around one base subscription. But with the technology disclosed herein the modeling better reflects what is actually sold to subscribers, e.g., the product itself. As mentioned above, a “product” is more than a piece of equipment, such as a smart phone. In the telecommunications environment, for example, a product may be voice calls for a certain price per minute, one price for daytime in another price for evenings. Another telecommunications product could be 500 short message service calls per month, but after that there is a certain price for each. Thus, a “product” may be a subscription package. Moreover, even if a consumer has already a subscription package, such package may currently be without capabilities for electronic data (e.g., for Internet surfing), but by using another product the original product may be upgraded (e.g., temporarily, e.g., for a weekend) to have electronic data service. In such case, the operator may offer a product which is a “free surf” weekend for a nominal amount. Thus, a “product” is a packaging for any particular commodity, whether apparatus or service, is sold. The product could be like subscriptions that recur (with the monthly fee and prescribed volume), or the product could be just a one-time offer (for example, 50 min. of data traffic). Or the product could be ten ring tones or five downloads of movies or other types of content. Another product to be a downloadable movie within twenty four hours. Thus, with the technology disclosed herein the seller or operator has the freedom to put configure a product in any way desirable. The charging system of the technology disclosed herein thus reflects the ways that the products are sold and consumed, and is therefore “product centric”.

The account centric approach asked the question “which account can I use?” The “product” centric, on the other hand, primarily asks “what products can be used?” Previously, with the conventional charging system, if a consumer purchased a subscription, the consumer might be able to select between perhaps five different subscription packages. But now with advantages of the technology disclosed herein and its product-centric charging system the customer may obtain a card that gives the customer access to a bundle of different products, and there may be selection between the different products and in different combinations.

The charging system 20 of the technology disclosed herein also has an ability to produce reports on how the product was consumed, e.g., what is left on the product. The charging system of the technology disclosed herein is indeed “product centric” since a focus is on the communication package as sold and how it is used. With the technology disclosed herein a big subscription now comprises many small subscriptions and more freedom for the customer to put together his/her own list of products.

It was also mentioned above that the charging system and particularly including product-centric charging manager 22 may be realized by a machine platform 50. A computer implementation of the machine platform may be realized by or implemented as one or more computer processors or controllers as those terms are herein expansively defined, and which may execute instructions stored on non-transient computer-readable storage media. In such a computer implementation the machine platform 50 may comprise, in addition to a processor(s), a memory section (which in turn can comprise random access memory; read only memory; an application memory (a non-transitory computer readable medium which stores, e.g., coded non instructions which can be executed by the processor to perform acts described herein); and any other memory such as cache memory, for example). Another example platform suitable for charging system 20(4) is that of a hardware circuit, e.g., an application specific integrated circuit (ASIC) wherein circuit elements are structured and operated to perform the various acts described herein.

The product-centric charging system of the technology disclosed herein provides numerous advantages and benefits, including but not limited to the following:
Easy to add/change/remove accounts without changing the consuming products, e.g., improved management of products. For example, new accounts can be added, and accounts can be changed and deleted, without the need of changing the rating configuration.
Sharing of assets/products between subscribers. The technology disclosed herein facilitates new possible offerings on the market.
The possibility of selecting which account to reserve/deduct from after the cost calculation. The technology disclosed herein thus provides, e.g., an improved possibility to select account based on one or more criteria which are different than in the conventional charging system, thereby providing greater flexibility.
Loosely coupling service used and the account from which to reserve/deduct money. This provides, e.g., an improved possibility to select an account based different criteria than in the conventional charging system, which again provides greater flexibility.
Promoting use of other, already deployed products account of a specific account type (account type addressing).
Introduction of the concept of account type classification, which can be used (via the account type addressing) by already-deployed products.

It was mentioned above that the access network 36 can be any suitable type of access network, and that a radio access network is just one example. In a typical cellular radio system, wireless terminals (also known as mobile stations and/or user equipment units (UEs)) communicate via a radio access network to one or more core networks. The radio access network (RAN) covers a geographical area which is divided into cell areas, with each cell area being served by a base station, e.g., a radio base station (RBS), which in some networks may also be called, for example, a “NodeB” (UMTS) or “eNodeB” (LTE). In some versions of the radio access network, several base stations are typically connected (e.g., by landlines or microwave) to a controller node (such as a radio network controller (RNC) or a base station controller (BSC)) which supervises and coordinates various activities of the plural base stations connected thereto. The radio network controllers are typically connected to one or more core networks.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. A method of operating a charging system comprising using a processor and a memory combined with the processor for:
defining a pool of plural asset accounts and classifying the asset accounts of the account pool according to one or more account type classifications;
storing at least one appropriate account type classification for a product;
upon receiving an indication of a service request involving the product, obtaining at least one appropriate account type classification for the product;
selecting from the pool of plural asset accounts one or more of the asset accounts belonging to the at least one appropriate account type classification to charge for the service request involving the product.

2. The method of claim 1, further comprising:
storing product charging or offering information for the product; and
using the product charging/offering information to determine an amount to charge for the service request.

3. The method of claim 1, further comprising selecting, from the pool of plural asset accounts, a selected asset account to charge for the service request involving the product, the selected asset account belonging to the at least one appropriate account type classification and being sponsored by another product.

4. The method of claim 3, further comprising using a product specification of another product stored in the charging system to identify sponsorship of the selected asset account.

5. The method of claim 1, further comprising determining whether to create in the pool of plural asset accounts a product asset account for the product, the product asset account being classified according to the at least one appropriate account type classification for the product.

6. The method of claim 5, further comprising, upon creating the product asset account for the product, identifying the product asset account as a sponsored product asset account, only the product which sponsors the sponsored product asset account being eligible to fund the sponsored product asset account.

7. The method of claim 6, further comprising:
for the product, storing in the charging system a product specification which defines the at least one appropriate account type classification for the product;
using the product specification for determining whether to create the product asset account for the product.

8. The method of claim 1, further comprising classifying the asset accounts of the pool of plural asset accounts according to one or more pre-defined account type classifications, the at least one appropriate account type classification being one of the pre-defined account type classifications.

9. The method of claim 1, further comprising:
for the product, storing in the charging system a product specification which defines the at least one appropriate account type classification for the product; and
upon receiving the indication of the service request involving the product, obtaining from the product specification the at least one appropriate account type classification for the product and using the at least one appropriate account type classification to select the one or more of the asset accounts belonging to the at least one appropriate account type classification to charge for the service request involving the product.

10. The method of claim 1, further comprising associating, with each account type classification, plural account type parameters, the account type parameters comprising at least one of an account type unit of measure and an account type selection rule.

11. The method of claim 10, further comprising using the account type selection rule to sequence charging for the service request from one or more asset accounts that belong to the at least one appropriate account type classification.

12. The method of claim 1, further comprising associating, with each account type classification, plural account type parameters, the account type parameters comprising an account type unit of measure.

13. The method of claim 1, further comprising:
maintaining a pool of plural products and, for each product in the pool, storing an indication of at least one of the appropriate account type classifications;
dynamically changing the constituent members of at least one of the pool of plural products and the pool of plural asset accounts during run time of the charging system.

14. The method of claim 1, further comprising using a logic processing circuit to perform the acts of claim 1.

15. A method of operating a charging system, the method comprising using a using a processor and a memory combined with the processor to:
define a pool of plural asset accounts and classifying the asset accounts of the account pool according to one or more account type classifications;
maintain a pool of plural products and, for each product in the pool, store an indication of at least one appropriate account type classification;
handle service requests for the products in the pool of plural products by using the indication of the at least one appropriate account type classification associated with the respective products to select from the pool of plural asset accounts one or more of the asset accounts to charge for the respective service requests; and,
dynamically change contents of one or both of the pool of plural asset accounts and the pool of plural products during run time of the logic processing circuit.

16. A charging system comprising:
a logic processing circuit comprising a processor and a memory combined with the processor;
an asset account database;
a product specification database;
wherein the logic processing circuit is configured to:
define in the asset account database a pool of plural asset accounts and to classify the asset accounts of the account pool according to one or more account type classifications;
store in the product specification database at least one appropriate account type classification for a product;
upon receiving an indication of a service request involving the product, to obtain from the product specification database the at least one appropriate account type classification for the product;
select from the pool of plural asset accounts one or more of the asset accounts belonging to the at least one appropriate account type classification to charge for the service request involving the product.

17. The system of claim 16, wherein the logic processing circuit is further configured to:
store, for the product, product charging or offering information (44); and
use the product offering information (44) to determine an amount to charge for the service request.

18. The system of claim 16, wherein the logic processing circuit is further configured to select, from the pool of plural asset accounts, a selected asset account to charge for the service request involving the product, the selected asset account belonging to the at least one appropriate account type classification and being sponsored by another product.

19. The system of claim 18, wherein the logic processing circuit is further configured to use a product specification of the another product stored in the charging system to identify sponsorship of the selected asset account.

20. The system of claim 16, wherein the logic processing circuit is further configured to determine whether to create in the pool of plural asset accounts a product asset account for the product, the product asset account being classified according to the at least one account type classification for the product.

21. The system of claim 20, wherein the logic processing circuit is further configured, upon creating the product asset account for the product, to identify the product asset account as a sponsored product asset account, only the product which sponsors the product asset account being eligible to fund the sponsored product asset account.

22. The system of claim 20, wherein the logic processing circuit is further configured to:
for the product, store in the charging system a product specification which defines the at least one appropriate account type classification for the product;
use the product specification for determining whether to create the product asset account for the product.

23. The system of claim 16, wherein the logic processing circuit is further configured to classify the asset accounts of the pool of plural asset accounts according to one or more pre-defined account type classifications, the at least one appropriate account type classification being one of the pre-defined account type classifications.

24. The system of claim 16, wherein the logic processing circuit is further configured to:
for the product, store in the charging system a product specification which defines the at least one appropriate account type classification for the product; and
upon receiving from the telecommunications network the indication of the service request involving the product, obtain from the product specification the at least one appropriate account type classification for the product and using the at least one appropriate account type classification to select the one or more of the asset accounts belonging to the at least one appropriate account type classification to charge for the service request involving the product.

25. The system of claim 16, wherein the logic processing circuit is further configured to associate, with each account type classification, plural account type parameters, the account type parameters comprising at least one of an account type unit of measure and an account type selection rule.

26. The system of claim 25, wherein the logic processing circuit is further configured to use the account type selection rule to sequence charging for the service request from one or more asset accounts that belong to the appropriate account type classification.

27. The system of claim 16, wherein the logic processing circuit is further configured to associate, with each account type classification, plural account type parameters, the account type parameters comprising an account type unit of measure.

28. The system of claim 16, wherein the logic processing circuit is further configured to:
maintain a pool of plural products and, for each product in the pool, to store an indication of one of the account type classifications;
dynamically change the constituent members of at least one of the pool of plural products and the pool of plural asset accounts during run time of the charging system.
